(19) United States
(12) Patent Application Publication
(10) Pub. No.: US 2025/0149665 A1
(43) Pub. Date: May 8, 2025

(54) BATTERY PACK AND METHOD FOR REMOVING HYDROGEN SULFIDE IN BATTERY PACK

(71) Applicant: TOYOTA JIDOSHA KABUSHIKI KAISHA, Aichi-ken (JP)

(72) Inventor: Kunimitsu YAMAMOTO, Kasugai-shi (JP)

(21) Appl. No.: 18/922,421

(22) Filed: Oct. 22, 2024

(30) Foreign Application Priority Data
Nov. 2, 2023 (JP) 2023-188933

(51) Int. Cl. H01M 10/52; H01M 10/0562; H01M 10/48; H01M 10/615; H01M 50/367

(52) U.S. Cl. CPC H01M 10/52; H01M 10/0562; H01M 10/486; H01M 10/615; H01M 50/367

(57) ABSTRACT

The present disclosure provides a battery pack in which hydrogen sulfide that may be generated from a battery containing a sulfide solid electrolyte can be effectively removed, and a method for removing such hydrogen sulfide in a battery pack. A battery pack 1 of the present disclosure comprises an outer container 10, batteries 20, which are housed in the outer container 10 and each contain a sulfide solid electrolyte, and a hydrogen sulfide absorbent 40, which is housed in the outer container 10, or arranged in a flow path 30 communicating with the inside of the outer container 10. The hydrogen sulfide absorbent is selected from the group consisting of zinc oxide, limestone, dolomite, and a combination thereof. The method for removing hydrogen sulfide in a battery pack according to the present disclosure comprises removing hydrogen sulfide using a hydrogen sulfide absorbent in a battery pack of the present disclosure.

### FIELD

The present disclosure relates to a battery pack; and a method for removing hydrogen sulfide in a battery pack.

### BACKGROUND

Battery packs comprising plural batteries are known. When the batteries contain a sulfide solid electrolyte, the sulfide solid electrolyte may react with water to generate hydrogen sulfide (H₂S). In this regard, technologies for inhibiting an increase in the concentration of hydrogen sulfide in a battery pack have been developed.

For example, PTL 1 discloses an all-solid-state battery pack configured such that: all-solid-state battery cells therein each contain a positive electrode, a negative electrode, and a sulfide-based solid electrolyte; when the temperature of an all-solid-state battery cell increases to a threshold or higher, an inert gas is blown to the all-solid-state battery cell having the increased temperature; and, when the hydrogen sulfide concentration increases to a threshold or higher, a basic gas is blown in addition to the inert gas.

PTL 2 discloses a battery pack to be mounted on a mobile body, which battery pack comprises: a battery case that houses therein all-solid-state batteries each containing a sulfur-based material in a positive electrode and/or a solid electrolyte; and an adsorbent that is arranged on a bottom part in the battery case and adsorbs hydrogen sulfide, wherein the adsorbent is arranged on the outer periphery of the bottom part.

### CITATION LIST

### Patent Literature

[PTL 1] Japanese Unexamined Patent Publication (Kokai) No. 2022-014295

[PTL 2] Japanese Unexamined Patent Publication (Kokai) No. 2022-167149

### SUMMARY

### Technical Problem

An object of the present disclosure is to provide a battery pack in which hydrogen sulfide that may be generated from a battery containing a sulfide solid electrolyte can be effectively removed, and a method for removing such hydrogen sulfide in a battery pack.

### Solution to Problem

The present disclosers have discovered that the above-described problems can be solved by the following means.

### Aspect 1

A battery pack,
wherein the battery pack comprises:
an outer container;
a battery which is housed in the outer container and contains a sulfide solid electrolyte; and
a hydrogen sulfide absorbent which is housed in the outer container, or arranged in a flow path communicating with the inside of the outer container, and
wherein the hydrogen sulfide absorbent is selected from the group consisting of zinc oxide, limestone, dolomite, and a combination thereof.

### Aspect 2

The battery pack according to Aspect 1, further comprising a heater which heats the hydrogen sulfide absorbent.

### Aspect 3

The battery pack according to Aspect 2, wherein a power source of the heater is the battery.

### Aspect 4

The battery pack according to any one of Aspects 1 to 3, wherein
the flow path is a circulation path in which a gas inside the outer container is circulated, and
the battery pack further comprises an oxygen absorbent which is housed in the outer container, or arranged in the circulation path communicating with the inside of the outer container.

### Aspect 5

A method for removing hydrogen sulfide in a battery pack, wherein
the battery pack comprises:
an outer container;
a battery which is housed in the outer container and contains a sulfide solid electrolyte; and
a hydrogen sulfide absorbent which is housed in the outer container, or arranged in a flow path communicating with the inside of the outer container,
the hydrogen sulfide absorbent is selected from the group consisting of zinc oxide, limestone, dolomite, and a combination thereof, and
the method comprises removing the hydrogen sulfide using the hydrogen sulfide absorbent.

### Aspect 6

The method according to Aspect 5, wherein
the battery pack further comprises a heater which heats the hydrogen sulfide absorbent, and
the method further comprises heating the hydrogen sulfide absorbent using the heater when one or more values selected from the temperature, the pressure, and the hydrogen sulfide concentration of the battery pack are equal to or higher than their thresholds.

### Aspect 7

The method according to Aspect 5 or 6, wherein
the flow path is an exhaust flow path through which a gas inside the outer container is discharged to the outside of the outer container,
the hydrogen sulfide absorbent is arranged in the exhaust flow path, and
the method further comprises discharging the gas from the exhaust flow path when the temperature of the hydrogen sulfide absorbent is equal to or higher than its threshold.

### Aspect 8

The method according to Aspect 5 or 6, wherein
the flow path is a circulation path in which a gas inside the outer container is circulated,
the battery pack further comprises an oxygen absorbent which is housed in the outer container, or arranged in the circulation path communicating with the inside of the outer container, and
the method further comprises removing oxygen inside the battery pack using the oxygen absorbent.

### Aspect 9

The method according to Aspect 8, further comprising performing circulation in the circulation path when one or more values selected from the temperature, the pressure, and the hydrogen sulfide concentration of the battery pack are equal to or higher than their thresholds.

### Advantageous Effects of Invention

According to the present disclosure, the following can be provided: a battery pack in which hydrogen sulfide that may be generated from a battery containing a sulfide solid electrolyte can be effectively removed; and a method for removing such hydrogen sulfide in a battery pack.

### BRIEF DESCRIPTION OF DRAWINGS

FIG. 1 is a schematic drawing that illustrates one example of the battery pack of the present disclosure.

FIG. 2 is a schematic drawing that illustrates another example of the battery pack of the present disclosure.

FIG. 3 is a schematic drawing that illustrates yet another example of the battery pack of the present disclosure.

FIG. 4 is a flow chart that illustrates one example of the method for removing hydrogen sulfide in a battery pack according to the present disclosure.

FIG. 5 is a flow chart that illustrates another example of the method for removing hydrogen sulfide in a battery pack according to the present disclosure.

FIG. 6 is a flow chart that illustrates yet another example of the method for removing hydrogen sulfide in a battery pack according to the present disclosure.

FIG. 7 is a graph showing the hydrogen sulfide absorption capacity of zinc oxide and that of limestone depending on the temperature.

### DESCRIPTION OF EMBODIMENTS

Embodiments of the present disclosure will now be described in detail. The present disclosure is, however, not limited to the below-described embodiments, and can be carried out with various modifications within the scope of the gist of the disclosure.

The battery pack of the present disclosure will now be described referring to the drawings. It is noted here that the dimensional relationships in the drawings do not reflect the actual dimensional relationships.

### Battery Pack

As illustrated in FIG. 1, a battery pack 1 of the present disclosure comprises an outer container 10, batteries 20, which are housed in the outer container 10 and each contain a sulfide solid electrolyte, and a hydrogen sulfide absorbent 40, which is housed in the outer container 10, or arranged in a flow path 30 communicating with the inside of the outer container 10. The hydrogen sulfide absorbent is selected from the group consisting of zinc oxide, limestone, dolomite, and a combination thereof.

As described above, in a battery containing a sulfide solid electrolyte, the sulfide solid electrolyte may react with water to generate hydrogen sulfide. Further, when this battery is exposed to abnormal heat, the temperature of the generated hydrogen sulfide is increased, as a result of which high-temperature hydrogen sulfide may be discharged to the outside of an outer container of a battery pack.

In this regard, the present disclosers have discovered that, by arranging a hydrogen sulfide absorbent selected from the group consisting of zinc oxide, limestone, dolomite, and a combination thereof in the outer container of the battery pack or in a flow path communicating with the inside of the outer container, hydrogen sulfide generated in the outer container can be effectively removed.

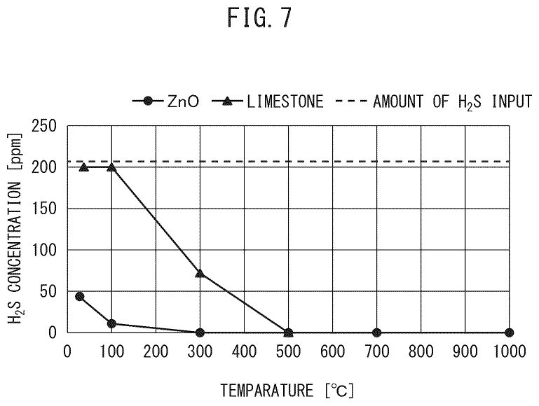

According to the results of the investigation by the present disclosers, as shown in FIG. 7, zinc oxide exhibits a high hydrogen sulfide absorption capacity in a range of room temperature to 300° C., while limestone and dolomite exhibit a high hydrogen sulfide absorption capacity at a temperature of 300° C. or higher. Therefore, by using these hydrogen sulfide absorbents singly or in combination, generated hydrogen sulfide can be effectively removed. In other words, at a relatively low temperature (in a range of room temperature to 300° C.), hydrogen sulfide can be effectively removed using zinc oxide. At a relatively high temperature (300° C. or higher), hydrogen sulfide can be effectively removed using limestone and/or dolomite. In a range of the relatively low temperature to the relatively high temperature, hydrogen sulfide can be effectively removed using zinc oxide in combination with limestone and/or dolomite.

Constituents of the battery pack of the present disclosure will now be described.

### Outer Container

As illustrated in FIG. 1, in a first embodiment, the battery pack 1 of the present disclosure comprises the outer container 10. A size, a shape, and the like of the outer container 10 are not particularly limited, as long as, for example, the batteries 20, the hydrogen sulfide absorbent 40 and, optionally, an oxygen absorbent can be housed and the flow path 30 can be arranged in the outer container 10. A material of the outer container is also not particularly limited and may be, for example, a metal such as aluminum or stainless steel.

### Battery

As illustrated in FIG. 1, the battery pack 1 of the present disclosure comprises the batteries 20 which are housed in the outer container 10 and each contain a sulfide solid electrolyte. The batteries may each contain the sulfide solid electrolyte in a positive electrode active material layer and/or a negative electrode active material layer. When the batteries are solid-state batteries, the batteries may each contain the sulfide solid electrolyte in a solid electrolyte layer. In other words, the batteries 20 may be sulfide solid-state batteries each containing the sulfide solid electrolyte in a solid electrolyte layer. In the present disclosure, the batteries may each be a battery in which an electrode laminate obtained by stacking layers such as a current collector layer, an electrode active material layer, and an electrolyte layer is housed in a laminated film, i.e. a so-called laminated battery (also referred to as “pouch battery”).

Regarding the present disclosure, the term “solid-state battery” means a battery in which at least a solid electrolyte is used as an electrolyte; therefore, a solid-state battery may contain, as an electrolyte, a combination of a solid electrolyte and a liquid electrolyte. Further, the solid-state battery of the present disclosure may be an all-solid-state battery, i.e. a battery in which only a solid electrolyte is used as an electrolyte.

The batteries according to the present disclosure may be lithium ion batteries and, in this case, examples of the sulfide solid electrolyte comprise, but not limited to, sulfide amorphous solid electrolytes, sulfide crystalline solid electrolytes, and argyrodite-type solid electrolytes. Specific examples of the sulfide solid electrolyte comprise, but not limited to: Li₂S—P₂S₅-based electrolytes (e.g., Li₇P₃S₁₁, Li₃PS₄, and Li₈P₂S₉), Li₂S—SiS₂, LiI—Li₂S—SiS₂, LiI—Li₂S—P₂S₅, LiI—LiBr—Li₂S—P₂S₅, Li₂S—P₂S₅—GeS₂ (e.g., Li₁₃GeP₃S₁₆ and Li₁₀GeP₂S₁₂), LiI—Li₂S—P₂O₅, LiI—Li₃PO₄—P₂S₅, and Li₇₋ₓPS₆₋ₓClₓ; and combinations thereof.

The sulfide solid electrolyte may be a glass or a crystallized glass (glass-ceramic).

The batteries 20 housed in the outer container 10 are electrically connected in series, in parallel, or in a combination of series and parallel connections. FIG. 1 schematically illustrates plural batteries 20; however, the number of batteries housed in the outer container 10 may be 1. The batteries 20 may take any form known in the art, such as a layered-type or wound-type form. When the batteries 20 are each composed of two or more unit batteries, the unit batteries in each battery 20 are electrically connected in series, in parallel, or in a combination of series and parallel connections. FIG. 1 schematically illustrates that plural batteries are arranged in parallel in the outer container 10; however, an arrangement of the batteries in the outer container 10 is not particularly limited, and any arrangement may be adopted. Accordingly, the plural batteries 20 may be stacked on one another, or may be arranged apart from each other.

### Hydrogen Sulfide Absorbent

As illustrated in FIG. 1, the battery pack 1 of the present disclosure comprises the hydrogen sulfide absorbent 40 which is housed in the outer container 10, or arranged in the flow path 30 communicating with the inside of the outer container 10. FIG. 1 illustrates an aspect in which the hydrogen sulfide absorbent 40 is arranged in the flow path 30; however, as described above, the hydrogen sulfide absorbent 40 may be housed in the outer container 10.

The hydrogen sulfide absorbent is selected from the group consisting of zinc oxide, limestone, dolomite, and a combination thereof. As described above, zinc oxide exhibits a high hydrogen sulfide absorption capacity in a range of room temperature to 300° C., while limestone and dolomite exhibit a high hydrogen sulfide absorption capacity at a temperature of 300° C. or higher. Therefore, by using these hydrogen sulfide absorbents singly or in combination, generated hydrogen sulfide can be effectively removed.

### Heater

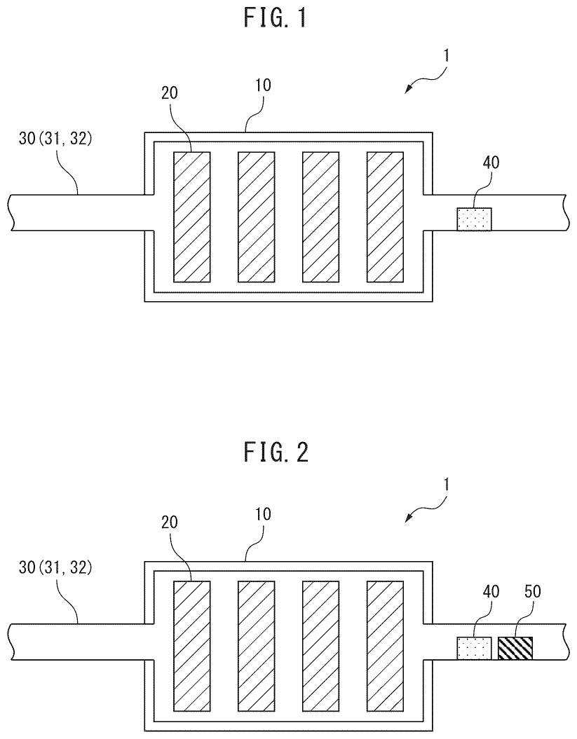

As illustrated in FIG. 2, the battery pack 1 of the present disclosure may further comprise a heater 50 which heats the hydrogen sulfide absorbent 40. By adopting such a configuration, particularly the absorption of hydrogen sulfide by limestone and dolomite, which are hydrogen sulfide absorbents operating at a relatively high temperature, can be facilitated.

A power source of the heater may be a battery housed in the outer container. By this, the state of charge (SOC) of the battery housed in the outer container can be reduced when hydrogen sulfide is generated.

The above is the first embodiment of the battery pack of the present disclosure.

### Flow Path

In a second embodiment, the flow path 30 may be an exhaust flow path 31 through which a gas inside the outer container 10 is discharged to the outside of the outer container 10. In other words, in this embodiment, the battery pack 1 does not have to be closed.

In a third embodiment, the flow path 30 may be a circulation path 32 in which a gas inside the outer container 10 is circulated. In other words, in this embodiment, the battery pack 1 may be closed. When the below-described oxygen absorbent is used, the absorption of oxygen by this oxygen absorbent is facilitated by allowing the gas inside the outer container 10 to circulate.

### Oxygen Absorbent

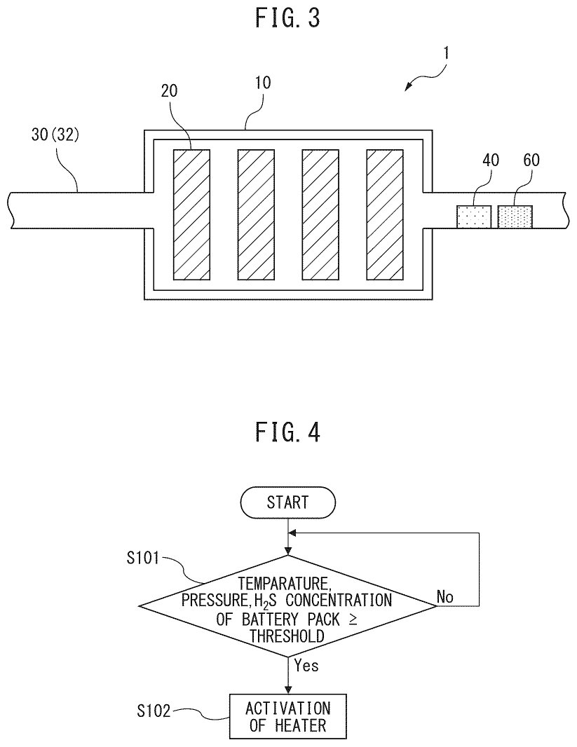

As illustrated in FIG. 3, in the third embodiment, the battery pack 1 of the present disclosure may further comprise an oxygen absorbent 60 which is housed in the outer container 10, or arranged in the circulation path 32 communicating with the inside of the outer container 10. FIG. 3 illustrates an aspect in which the oxygen absorbent 60 is arranged in the circulation path 32; however, as described above, the oxygen absorbent 60 may be housed in the outer container 10.

The oxygen absorbent is not particularly limited, as long as it is a material capable of absorbing oxygen. The oxygen absorbent may be a material that can absorb oxygen by reacting with oxygen, i.e. being oxidized. Examples of such a material comprise metals such as iron, and organic compounds such as vitamin C. The oxygen absorbent may also be a material that can absorb oxygen by being oxidized at a temperature of 100° C. or higher. One example of such a material is paraffin. For example, when the hydrogen sulfide absorbent is in a powder form, paraffin can not only absorb oxygen at a prescribed temperature, but also function as a binder of the hydrogen sulfide absorbent.

### Method for Removing Hydrogen Sulfide in Battery Pack

In a first embodiment, the method for removing hydrogen sulfide in a battery pack according to the present disclosure comprises removing hydrogen sulfide using a hydrogen sulfide absorbent in a battery pack which comprises an outer container, a battery that is housed in the outer container and contains a sulfide solid electrolyte, and the hydrogen sulfide absorbent that is housed in the outer container or arranged in a flow path communicating with the inside of the outer container, and in which the hydrogen sulfide absorbent is selected from the group consisting of zinc oxide, limestone, dolomite, and a combination thereof.

With regard to the battery pack in this method of the present disclosure, reference can be made to the above description relating to the battery pack of the present disclosure.

The method of the present disclosure comprises removing hydrogen sulfide using a hydrogen sulfide absorbent selected from the group consisting of zinc oxide, limestone, dolomite, and a combination thereof. By employing this method, as described above, hydrogen sulfide generated in the outer container can be effectively removed.

The battery pack may further comprise a heater that heats the hydrogen sulfide absorbent.

A power source of the heater may be the battery housed in the outer container.

With regard to the heater and its power source, reference can be made to the above description relating to the battery pack of the present disclosure.

The method of the present disclosure may further comprise heating the hydrogen sulfide absorbent using the heater when one or more values selected from the temperature, the pressure, and the hydrogen sulfide concentration of the battery pack are equal to or higher than their thresholds.

Regarding the present disclosure, the “temperature of the battery pack” may be, for example, the temperature inside the outer container, the temperature of the battery, or the temperature inside the flow path. The “pressure of the battery pack” may be, for example, the pressure inside the outer container, or the pressure inside the flow path. The “hydrogen sulfide concentration of the battery pack” may be, for example, the concentration of hydrogen sulfide inside the outer container, or the concentration of hydrogen sulfide inside the flow path.

A method of measuring the temperature of the battery pack is not particularly limited, and examples thereof comprise a measurement method using a heat detection unit such as a temperature sensor. A method of measuring the pressure of the battery pack is not particularly limited, and examples thereof comprise a measurement method using a pressure detection unit such as a pressure sensor. A method of measuring the hydrogen sulfide concentration of the battery pack is also not particularly limited, and examples thereof comprise a measurement method using a hydrogen sulfide concentration detection unit such as a hydrogen sulfide concentration sensor. The temperature, the pressure, and the hydrogen sulfide concentration of the battery pack may be constantly monitored by, for example, the above-described sensors.

A threshold of the temperature of the battery pack is not particularly limited and may be, for example, a value that can be judged as the temperature causing the generation of hydrogen sulfide. The heating with a heater may be omitted when the temperature of the battery pack is equal to or higher than the temperature at which limestone and dolomite effectively operate as hydrogen sulfide absorbents, for example, 300° C. or higher.

A threshold of the pressure of the battery pack is not particularly limited and may be, for example, a value that can be judged to represent an increase in the pressure caused by the generation of hydrogen sulfide.

A threshold of the hydrogen sulfide concentration of the battery pack is not particularly limited and may be, for example, a value that can be measured as the hydrogen sulfide concentration indicating the generation of hydrogen sulfide.

As described above, the heater is used for heating particularly limestone and dolomite that are hydrogen sulfide absorbents operating at a relatively high temperature; therefore, the temperature of the heating with the heater can be determined taking into consideration the temperature at which limestone and dolomite effectively operate as hydrogen sulfide absorbents.

The above is the first embodiment of the method of the present disclosure.

In a second embodiment, the flow path may be an exhaust flow path through which a gas inside the outer container is discharged to the outside of the outer container, and the hydrogen sulfide absorbent may be arranged in the exhaust flow path. In this case, the method of the present disclosure may further comprise discharging the gas from the exhaust flow path when the temperature of the hydrogen sulfide absorbent is equal to or higher than its threshold. The threshold of the temperature of the hydrogen sulfide absorbent can be designed as appropriate based on the temperature at which the hydrogen sulfide absorbent functions effectively. In other words, when the hydrogen sulfide absorbent is zinc oxide, the threshold can be set at a relatively low temperature, while when the hydrogen sulfide absorbent is limestone or dolomite, the threshold can be set at a relatively high temperature. By employing this method, the discharge of the gas from the exhaust flow path can be performed at a temperature at which the hydrogen sulfide absorbent functions effectively; therefore, discharge of hydrogen sulfide to the outside of the outer container can be inhibited.

A method of measuring the temperature of the hydrogen sulfide absorbent is not particularly limited, and examples thereof comprise a measurement method using a heat detection unit such as a temperature sensor.

In a third embodiment, the flow path may be a circulation path in which a gas inside the outer container is circulated, and the battery pack further comprises an oxygen absorbent which is housed in the outer container, or arranged in the circulation path communicating with the inside of the outer container. In this case, the method of the present invention may further comprise removing oxygen inside the battery pack using the oxygen absorbent.

In the third embodiment, the method of the present disclosure may further comprise performing circulation in the circulation path when one or more values selected from the temperature, the pressure, and the hydrogen sulfide concentration of the battery pack are equal to or higher than their thresholds. By employing this method, the energy required for the circulation can be reduced as compared to a case of constantly circulating the gas inside the outer container.

In the method of the present disclosure, the battery pack may comprise a control unit. The control unit may be connected to each of the heat detection unit, the pressure detection unit, and the hydrogen sulfide concentration detection unit. By this, the control unit can activate the heater when one or more values selected from the temperature, the pressure, and the hydrogen sulfide concentration of the battery pack are equal to or higher than their thresholds. In addition, the control unit can allow the discharge of the gas from the exhaust flow path to be performed when the temperature of the hydrogen sulfide absorbent is equal to or higher than its threshold. Further, the control unit can allow the circulation in the circulation path to be performed when the temperature, the pressure, and the hydrogen sulfide concentration of the battery pack are equal to or higher than their thresholds.

The method for removing hydrogen sulfide in a battery pack according to the present disclosure will now be described by referring to FIGS. 4 to 6.

FIG. 4 is a flow chart that illustrates one example of the first embodiment of the method for removing hydrogen sulfide in a battery pack according to the present disclosure. In the first embodiment, the flow path of the battery pack may be an exhaust flow path or a circulation path. Further, the battery pack may or may not further comprise an oxygen absorbent in addition to the hydrogen sulfide absorbent.

As illustrated in FIG. 4, in the first embodiment, first, at the start, one or more values selected from the temperature, the pressure, and the hydrogen sulfide concentration of the battery pack are monitored by the heat detection unit, the pressure detection unit, and/or the hydrogen sulfide concentration detection unit.

Next, by the control unit, the temperature, the pressure, and the hydrogen sulfide concentration of the battery pack that are transmitted from each detection unit are compared with their respective thresholds (S101). At this point, when all values selected from the temperature, the pressure, and the hydrogen sulfide concentration of the battery pack are less than their respective thresholds, the monitoring by each detection unit is continued.

On the other hand, when one or more values selected from the temperature, the pressure, and the hydrogen sulfide concentration of the battery pack are equal to or higher than their respective thresholds, the control unit activates the heater for heating the hydrogen sulfide absorbent (S102).

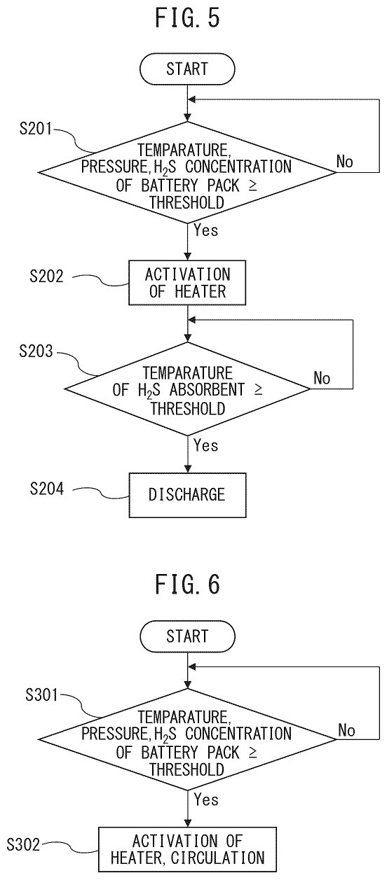

FIG. 5 is a flow chart that illustrates one example of the second embodiment of the method for removing hydrogen sulfide in a battery pack according to the present disclosure. In the second embodiment, the flow path of the battery pack is an exhaust flow path.

As illustrated in FIG. 5, the process from the start to the S202 in the second embodiment are the same as the process from the start to the S102 in the first embodiment.

After the S202, by the control unit, the temperature of the hydrogen sulfide absorbent that is transmitted from the heat detection unit is compared with its threshold (S203). At this point, when the temperature of the hydrogen sulfide absorbent is lower than the threshold, heating of the hydrogen sulfide absorbent by the heater is continued.

On the other hand, when the temperature of the hydrogen sulfide absorbent is equal to or higher than the threshold, the control unit performs discharge of the gas from the exhaust flow path (S204).

FIG. 6 is a flow chart that illustrates one example of the third embodiment of the method for removing hydrogen sulfide in a battery pack according to the present disclosure. In the third embodiment, the flow path of the battery pack is a circulation path, and the battery pack further comprises an oxygen absorbent in addition to the hydrogen sulfide absorbent.

As illustrated in FIG. 6, the start and the S301 in the third embodiment is the same as the start and the S101 in the first embodiment.

In the S301, when one or more values selected from the temperature, the pressure, and the hydrogen sulfide concentration of the battery pack are equal to or higher than their respective thresholds, the control unit not only activates the heater for heating the hydrogen sulfide absorbent, but also performs circulation in the circulation path (S302).

### Reference Signs List

1: battery pack
10: outer container
20: battery
30: flow path
31: exhaust flow path
32: circulation path
40: hydrogen sulfide absorbent
50: heater
60: oxygen absorbent

1. A battery pack,
wherein the battery pack comprises:
an outer container;
a battery which is housed in the outer container and contains a sulfide solid electrolyte; and
a hydrogen sulfide absorbent which is housed in the outer container, or arranged in a flow path communicating with the inside of the outer container, and
wherein the hydrogen sulfide absorbent is selected from the group consisting of zinc oxide, limestone, dolomite, and a combination thereof.

2. The battery pack according to claim 1, further comprising a heater which heats the hydrogen sulfide absorbent.

3. The battery pack according to claim 2, wherein a power source of the heater is the battery.

4. The battery pack according to claim 1, wherein
the flow path is a circulation path in which a gas inside the outer container is circulated, and
the battery pack further comprises an oxygen absorbent which is housed in the outer container, or arranged in the circulation path communicating with the inside of the outer container.

5. A method for removing hydrogen sulfide in a battery pack, wherein
the battery pack comprises:
an outer container;
a battery which is housed in the outer container and contains a sulfide solid electrolyte; and
a hydrogen sulfide absorbent which is housed in the outer container, or arranged in a flow path communicating with the inside of the outer container,
the hydrogen sulfide absorbent is selected from the group consisting of zinc oxide, limestone, dolomite, and a combination thereof, and
the method comprises removing the hydrogen sulfide using the hydrogen sulfide absorbent.

6. The method according to claim 5, wherein
the battery pack further comprises a heater which heats the hydrogen sulfide absorbent, and
the method further comprises heating the hydrogen sulfide absorbent using the heater when one or more values selected from the temperature, the pressure, and the hydrogen sulfide concentration of the battery pack are equal to or higher than their thresholds.

7. The method according to claim 5, wherein
the flow path is an exhaust flow path through which a gas inside the outer container is discharged to the outside of the outer container,
the hydrogen sulfide absorbent is arranged in the exhaust flow path, and
the method further comprises discharging the gas from the exhaust flow path when the temperature of the hydrogen sulfide absorbent is equal to or higher than its threshold.

8. The method according to claim 5, wherein
the flow path is a circulation path in which a gas inside the outer container is circulated,
the battery pack further comprises an oxygen absorbent which is housed in the outer container, or arranged in the circulation path communicating with the inside of the outer container, and
the method further comprises removing oxygen inside the battery pack using the oxygen absorbent.

9. The method according to claim 8, further comprising performing circulation in the circulation path when one or more values selected from the temperature, the pressure, and the hydrogen sulfide concentration of the battery pack are equal to or higher than their thresholds.
